(19) United States
(12) Patent Application Publication
(10) Pub. No.: US 2026/0077446 A1
(43) Pub. Date: Mar. 19, 2026

(54) CUTTING-OFF AND GRINDING INTEGRATED MACHINE AND CONTROL METHOD THEREFOR

(71) Applicant: Fujian Skystone Intelligent Equipment Co., Ltd., Putian (CN)

(72) Inventors: Haiwei LI, Putian (CN); Xinghua LIANG, Putian (CN); Bo LI, Putian (CN); Zhiyuan YUAN, Putian (CN); Wenkai HUANG, Putian (CN); Zonghao CHEN, Putian (CN); Guanghu WANG, Putian (CN); Guangjian ZHENG, Putian (CN); Zhangyou YANG, Putian (CN); Dewei LIU, Putian (CN)

(73) Assignee: Fujian Skystone Intelligent Equipment Co., Ltd., Putian (CN)

(21) Appl. No.: 19/035,003

(22) Filed: Jan. 23, 2025

(30) Foreign Application Priority Data
Sep. 14, 2024 (CN) 202411288480.6
Jan. 15, 2025 (CN) 202520091609.8
Jan. 15, 2025 (CN) 202520091627.6

(51) Int. Cl. B24B 27/06; B24B 7/22; B24B 9/06; B24B 27/00; B26D 1/547; B26D 7/27

(52) U.S. Cl. CPC B24B 27/0633; B24B 27/0069; B26D 1/547; B26D 7/27; B24B 7/22; B24B 9/06

(57) ABSTRACT

The cutting-off and grinding integrated machine includes a machine body, a feeding component, a blanking component, a cutting-off component, a grinding component, and a transfer component. The cutting-off component, the feeding component, the grinding component and the blanking component are juxtaposed in the machine body in a width direction of the machine body; the grinding component includes plane grinding components and chamfer grinding components, the chamfer grinding components and the plane grinding components are integrally disposed, and the feeding component and the blanking component are both movable in a length direction of the machine body; and the transfer component includes a manipulator movable in the width and height directions of the machine body, and a blanking position of the feeding component, a feeding position of the blanking component and machining positions of the cutting-off component and the grinding component are all located on a moving path of the manipulator.

### CROSS-REFERENCE TO RELATED APPLICATIONS

This application claims priority to Chinese Patent Application No. 202411288480.6, filed on Sep. 14, 2024, Chinese Patent Application No. 202520091609.8, filed on Jan. 15, 2025, and Chinese Patent Application No. 202520091627.6, filed on Jan. 15, 2025, the contents of which are incorporated herein by reference in its entirety. All of the aforementioned patent applications are hereby incorporated by reference in their entireties.

### TECHNICAL FIELD

The present application relates to the field of crystal bar machining, in particular to a cutting-off and grinding integrated machine and a control method therefor.

### BACKGROUND

The statement shown here only provides background information related to the present application, and does not necessarily constitute the prior art.

Devices for machining silicon bars usually include a cutting-off machine, a squaring machine, a slicing machine and other machines that are used for cutting, squaring, slicing and other processes for the silicon bars, wherein the cutting-off machine is mainly used for cutting longer silicon bars into shorter silicon bars (that are usually round bars), the squaring machine is mainly used for cutting the cut round bars into square bars in length directions, and the slicing machine is mainly used for slicing the squared square bars to finally obtain thin silicon wafers to be used. With the development of the photovoltaic industry, there has also been a demand for silicon wafer products corresponding to half-bars (that are usually bars formed by cutting the above-mentioned square bars half and half in the length directions) on the market.

During the machining of the above-mentioned half-bar products, a half-bar machining device is usually used in the prior art in which the machining of half-bar products needs to be completed by respectively performing processes such as feeding, cutting, grinding and blanking on a to-be-machined crystal bar by means of a feeding component, a cutting-off component, a grinding component and a blanking component in sequence. For the layout of a machining component for each process of the device, with the grinding component as an example, it includes two kinds of machining parts, i.e., chamfer grinding components and plane grinding components, chamfer grinding and plane grinding are usually designed to be independent of each other, a longer grinding platform is required to be matched with the chamfer grinding components and the plane grinding components spaced on the grinding platform for machining, which leads to a greater overall device size, more structures and more cumbersomeness in maintenance. In addition, the transfer design for the three-axis movement of a manipulator is almost adopted in the existing machining device, and the layout of a corresponding movement structure of the manipulator also leads to the increase of the overall device size, an un-compact structure, the increase of a corresponding machining movement path of each process, the prolonging of a machining duration, and a certain impact on the machining efficiency.

### SUMMARY

Provided are a cutting-off and grinding integrated machine by which a volume of a device is reduced and the structural compactness is improved, and a control method therefor.

A cutting-off and grinding integrated machine includes a machine body, a feeding component, a blanking component, a cutting-off component, a grinding component, and a transfer component, wherein the cutting-off component, the feeding component, the grinding component and the blanking component are juxtaposed in the machine body in a width direction of the machine body; the grinding component includes plane grinding components and chamfer grinding components, the chamfer grinding components and the plane grinding components are integrally disposed, and the feeding component and the blanking component are both movable in a length direction of the machine body; and the transfer component includes a manipulator movable in the width and height directions of the machine body, and a blanking position of the feeding component, a feeding position of the blanking component and machining positions of the cutting-off component and the grinding component are all located on a moving path of the manipulator.

A control method for a cutting-off and grinding integrated machine is applied to the above-mentioned cutting-off and grinding integrated machine, and includes the following steps: after placing a crystal bar on the feeding component, moving the feeding component in the length direction of the machine body to convey the crystal bar to the blanking position of the feeding component; then, transversely moving the manipulator to the blanking position of the feeding component in the width direction of the machine body to grab the crystal bar, then, transversely moving the manipulator to the machining position of the cutting-off component again, and performing a cutting-off process by the cutting-off component; after completing the cutting-off process, grabbing the cut-off crystal bar by the manipulator and transversely moving the manipulator to the machining position of the grinding component, and sequentially performing a chamfer grinding process and a plane grinding process on the crystal bar by the chamfer grinding components and the plane grinding components; and after completing the chamfer grinding process and the plane grinding process, grabbing the ground crystal bar by the manipulator and transversely moving the manipulator to the feeding position of the blanking component, and conveying the crystal bar out of the machine body by the blanking component.

Beneficial effects lie in that the manipulator moves in the single width direction of the machine body by matching the cutting-off component, the feeding component, the grinding component and the blanking component that are juxtaposed with the manipulator, by which the fetching and storage of the crystal bar on the feeding component, the cutting-off component, the grinding component and the blanking component can be respectively completed; accordingly, compared with a traditional tri-axis manipulator, the manipulator is more simplified in related moving structure, reduced in weight and overall structural volume, compact in layout and convenient to subsequently maintain; adopted is the design of integrated layout of the chamfer grinding components and the plane grinding components, which can reduce the overall volume and improve the structural compactness as comparison with a traditional split spaced layout; in addition, by means of the layout of the feeding component between the cutting-off component and the grinding component, cutting-off and grinding processes can be spaced, and the phenomenon that wastes generated during machining in the two processes are splashed to another component to affect the machining precision can be avoided.

The manipulator transversely moves to grab the crystal bar and is respectively matched with the feeding component, the cutting-off component, the grinding component and the blanking component to complete cutting-off and grinding operations. By controlling the transverse movement of the manipulator, the structure can be simplified, a volume of a device can be reduced, the control stability can be improved, and it is also convenient to perform later maintenance operations.

### BRIEF DESCRIPTION OF THE DRAWINGS

FIG. 1 is a schematic structural view of a cutting-off and grinding integrated machine according to an embodiment.

FIG. 2 is a schematic structural view of a feeding component of a cutting-off and grinding integrated machine according to an embodiment.

FIG. 3 is a schematic structural view of a blanking component of a cutting-off and grinding integrated machine according to an embodiment.

FIG. 4 is a schematic structural view of a cutting-off component of a cutting-off and grinding integrated machine according to an embodiment.

FIG. 5 is a schematic structural view of another viewing angle of a cutting-off component of a cutting-off and grinding integrated machine according to an embodiment.

FIG. 6 is a side view of a cutting-off component of a cutting-off and grinding integrated machine according to an embodiment.

FIG. 7 is a schematic structural view of a portal frame of a grinding component of a cutting-off and grinding integrated machine according to an embodiment.

FIG. 8 is a schematic structural view of a grinding platform of a grinding component of a cutting-off and grinding integrated machine according to an embodiment.

FIG. 9 is a schematic enlarged view of part A in FIG. 8.

FIG. 10 is a schematic view shown when chamfer grinding components of a grinding component of a cutting-off and grinding integrated machine are disposed to be perpendicular to axes of plane grinding components corresponding to the chamfer grinding components according to an embodiment.

FIG. 11 is a schematic view shown when chamfer grinding components of a grinding component of a cutting-off and grinding integrated machine are disposed to be parallel to axes of plane grinding components corresponding to the chamfer grinding components according to an embodiment.

FIG. 12 is a schematic view shown when chamfer grinding components of a grinding component of a cutting-off and grinding integrated machine are disposed to be not perpendicular to axes of plane grinding components corresponding to the chamfer grinding components according to an embodiment.

FIG. 13 is a schematic structural view of a transfer component of a cutting-off and grinding integrated machine according to an embodiment.

FIG. 14 is a schematic structural view of a second cleaning component of a blanking component of a cutting-off and grinding integrated machine according to an embodiment.

FIG. 15 is a schematic structural view of a plane grinding component of a cutting-off and grinding integrated machine according to an embodiment.

FIG. 16 is a schematic structural view of a benchmarking sensor of a plane grinding component of a cutting-off and grinding integrated machine according to an embodiment.

FIG. 17 is a schematic structural view of an oilstone loss detection component of a cutting-off and grinding integrated machine according to an embodiment.

FIG. 18 is a schematic structural view of an anti-falling component of a cutting-off and grinding integrated machine according to an embodiment.

FIG. 19 is a schematic structural view of a third cleaning component of a manipulator of a cutting-off and grinding integrated machine according to an embodiment.

FIG. 20 is a schematic structural view of assembly of an air blowing component of a manipulator of a cutting-off and grinding integrated machine on a machine body according to an embodiment.

FIG. 21 is a schematic structural view of an air blowing component of a manipulator of a cutting-off and grinding integrated machine according to an embodiment.

FIG. 22 is a schematic structural view of first compression cylinders and an end gripping component of a grinding platform of a cutting-off and grinding integrated machine according to an embodiment.

FIG. 23 is a schematic structural view of a protective component of a cutting-off and grinding integrated machine according to an embodiment.

FIG. 24 is a schematic structural view of a benchmarking cleaning component of a cutting-off and grinding integrated machine according to an embodiment.

FIG. 25 is a schematic structural view of an air blowing pipe of a benchmarking cleaning component of a cutting-off and grinding integrated machine according to an embodiment.

FIG. 26 is a schematic structural view of an external protective cover of a cutting-off and grinding integrated machine according to an embodiment.

### DETAILED DESCRIPTION OF THE EMBODIMENTS

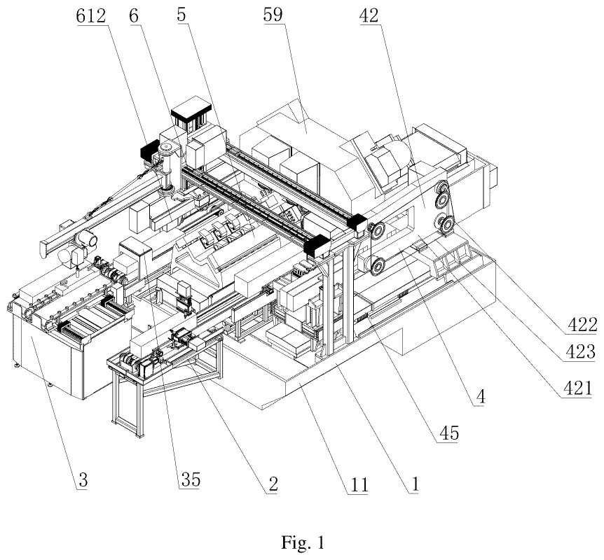

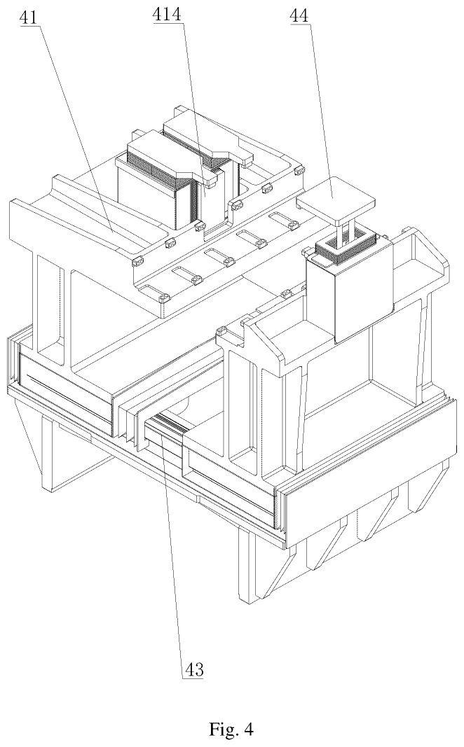

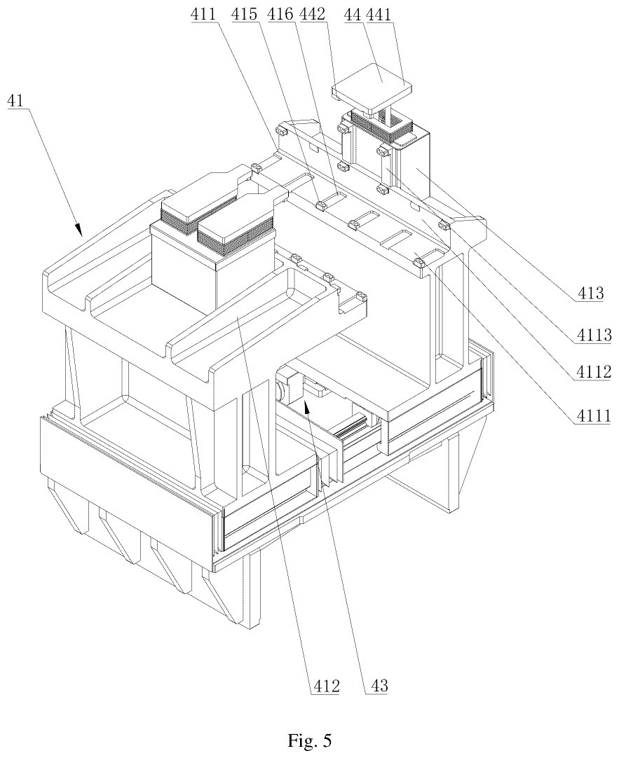

Referring to FIG. 1 to FIG. 26, a cutting-off and grinding integrated machine includes a machine body 1, a feeding component 2, a blanking component 3, a cutting-off component 4, a grinding component 5, and a transfer component 6, wherein the cutting-off component 4, the feeding component 2, the grinding component 5 and the blanking component 3 are juxtaposed in the machine body 1 in a width direction of the machine body 1; the grinding component 5 includes plane grinding components 57 and chamfer grinding components 58, the chamfer grinding components 58 and the plane grinding components 57 are integrally disposed, and the feeding component 2 and the blanking component 3 are both movable in a length direction of the machine body 1; and the transfer component 6 includes a manipulator 61 movable in the width and height directions of the machine body 1, and a blanking position of the feeding component 2, a feeding position of the blanking component 3 and machining positions of the cutting-off component 4 and the grinding component 5 are all located on a moving path of the manipulator 61.

It can be known from the above-mentioned description that beneficial effects lie in that the manipulator 61 moves in the single width direction of the machine body 1 by matching the cutting-off component 4, the feeding component 2, the grinding component 5 and the blanking component 3 that are juxtaposed with the manipulator 61, by which the fetching and storage of the crystal bar on the feeding component 2, the cutting-off component 4, the grinding component 5 and the blanking component 3 can be respectively completed; accordingly, compared with a traditional tri-axis manipulator 61, the manipulator 61 is more simplified in related moving structure, reduced in weight and overall structural volume, compact in layout and convenient to subsequently maintain; adopted is the design of integrated layout of the chamfer grinding components 58 and the plane grinding components 57, which can reduce the overall volume and improve the structural compactness as comparison with a traditional split spaced layout; in addition, by means of the layout of the feeding component 2 between the cutting-off component 4 and the grinding component 5, cutting-off and grinding processes can be spaced, and the phenomenon that wastes generated during machining in the two processes are splashed to another component to affect the machining precision can be avoided.

Further, the cutting-off component 4 includes a rack 45, a cutting-off apparatus 42, and loading abutments 41, the loading abutments 41 are disposed on two sides of a length direction of the rack 45, a cutting gap is disposed between the two loading abutments 41, and the two loading abutments 41 are movable face to face or back to back to adjust a size of the cutting gap; the two loading abutments 41 are combined to form a storage platform for storing a crystal bar; and the cutting-off apparatus 42 is movably disposed in the length direction of the rack 45 and passes through the cutting gap.

It can be known from the above-mentioned description that due to the design of the movable and adjustable cutting gap between the two loading abutments 41, crystal bar edge knocking caused when slight motion happens due to the over small cutting gap in a process that the cut crystal bar is clamped by the manipulator 61 can be avoided; in addition, due to the design of the adjustable cutting gap in a process that the crystal bar is fetched or stored, a design space for shortening a size of a device can also be provided, for example, in terms of the use of a cutting wire saw 423, if the cutting wire saw 423 stops on a cutting position of the crystal bar after cutting, the cutting wire saw 423 will spring to scratch the crystal bar in a spraying process, and thus, the cutting wire saw 423 needs to entirely advance in a cutting direction or entirely withdraw out of the cutting position of the crystal bar, the former will lead to the increase of the size of the device, for the latter, if spraying is performed when the cutting wire saw 423 passes through the conventional fixed smaller cutting gap, the cutting wire saw 423 will also spring to scratch the crystal bar, and for the latter, the design of the adjustable cutting gap provided in the present application can meet the rapid and safe wire withdrawing of the cutting wire saw 423 by providing a larger cutting gap without increasing the size of the device.

Further, the cutting-off apparatus 42 includes a mounting rack 421, a cutting wheel system 422, and a cutting wire saw 423, the cutting wheel system 422 is mounted on the mounting rack 421, the cutting wire saw 423 is wound on the cutting wheel system 422, and a distance of two adjacent segments of the cutting wire saw 423 in a cutting direction is greater than a length of the crystal bar; and during cutting, only one segment of the cutting wire saw 423 partially enters the cutting gap.

It can be known from the above-mentioned description that during a cutting-off operation, the cutting wheel system 422 rotates to drive the cutting wire saw 423 to move, and the crystal bar is cut off in a movement process of the mounting rack 421. Due to the design of the lengths of the two adjacent segments of wire saw parts of the cutting wire saw 423 and the length of the crystal bar, it is possible to avoid the situation that during the cutting-off operation, an adjacent segment of wire saw cuts off the crystal bar firstly to leave from the crystal bar, while the other segment of wire saw is still located between two half bars, when the other segment of wire saw leaves from the crystal bar, a distance between the two half bars is very short in a cutting-off process of the crystal bar, cutting parts will be continuously sprayed in the cutting-off process, and thus, a layer of water film will be formed between the two half bars, which finally makes the segment of wire saw still located in the crystal bar leave from the crystal bar to spring so as to scratch the cut crystal bar.

Further, each of the loading abutments 41 is provided with a compression component 44 abutting against a top of the crystal bar; and the compression component 44 includes a driving cylinder, a connecting plate 441, and a compression head 442, the driving cylinder is disposed on the loading abutment 41, a driving end of the driving cylinder is movable in a height direction of the loading abutment 41 and is connected with the connecting plate 441 parallel to the top of the crystal bar, and the compression head 442 is disposed on a portion, opposite to the top of the crystal bar, of the connecting plate 441.

It can be known from the above-mentioned description that by disposing the compression component 44, it is ensured that the crystal bar is kept fixed in the cutting-off process, and the cutting accuracy is guaranteed; by means of the movement of the driving end of the driving cylinder, the top of the crystal bar stored on the loading abutment 41 can be pressed by the compression head 442 so as to be fixed up and down.

Further, the compression component 44 further includes a first mounting seat 413, the driving cylinder is disposed in the first mounting seat 413, and the first mounting seat 413 is disposed on the loading abutment 41; and a positioning surface 4112 perpendicular to the loading abutment 41 is disposed on a side, close to the cutting gap, of the first mounting seat 413, and the positioning surface 4112 abuts against a side of the crystal bar.

It can be known from the above-mentioned description that on one hand, the first mounting seat 413 is used as a mounting space of the driving cylinder, and on the other hand, the positioning surface 4112 can abut against the side of the crystal bar, and thus, the crystal bar can be gripped and fixed when the two loading abutments 41 move in opposite directions.

Further, the loading abutment 41 and the positioning surface 4112 are provided with a protective part abutting against the crystal bar.

It can be known from the above-mentioned description that by disposing the protective part 23 on the loading abutment 41 and the positioning surface 4112, abrasion caused by contact between the crystal bar and each of the loading abutment 41 and the positioning surface 4112 when the crystal bar is stored and machined can be avoided, and the machining precision is guaranteed.

Further, the grinding component 5 includes a portal frame 59 and at least two sets of grinding wheels symmetrically disposed on two sides of the portal frame 59, the grinding wheels include chamfer grinding components 58 and plane grinding components 57, the chamfer grinding components 58 and the plane grinding components 57 are respectively disposed on front and rear sides of the portal frame 59, and each set of grinding wheels at least includes two groups of chamfer grinding components 58.

It can be known from the above-mentioned description that for the existing design of the plane grinding components 57 and the chamfer grinding components 58 that are split and spaced, the T-shaped plane grinding components 57 need to cross two machining paths, and middles thereof need to be supported by upright columns having strength high enough, and at the same time, the chamfer grinding components 58 also need to be supported by independent upright columns. By adopting the design that the integrated portal frame 59 is combined with the plane grinding components 57 and the chamfer grinding components 58, the single portal frame 59 can be used as a supporting structure for the plane grinding components 57 and the chamfer grinding components 58 at the same time to avoid the situation that supporting upright columns are disposed on the two machining paths to increase a width of a device. Under such a design, a design number of supporting structures can be reduced for the structure of the device, so that the overall structure is more compact, and it is also convenient to perform subsequent maintenance operations.

Further, the grinding component 5 further includes a grinding platform 51, the grinding platform 51 includes grinding seats 52 and a base 53, the grinding seats 52 are respectively disposed on two sides of the base 53, the grinding seats 52 are obliquely disposed, and a to-be-machined crystal bar is fixed to the grinding seats 52.

It can be known from the above-mentioned description that due to the design of the inclined grinding seats 52, a width of the traditional device laid for grinding is reduced, and the space of the device in a height direction is reasonably utilized; and at the same time, wastes generated in a machining process of the crystal bar can also leave from the crystal bar under the guide of the grinding seats 52 and the driving of self-gravity, so that the accumulated wastes are reduced.

Further, an included angle between a surface, to which the crystal bar is fixed, of each of the grinding seats 52 and an upper end surface of the base 53 is 45 degrees.

It can be known from the above-mentioned description that due to the design of the included angle between the surface, to which the crystal bar is fixed, of each of the grinding seats 52 and the upper end surface of the base 53, an angular bisector of corners on two sides of a cutting surface of the crystal bar can be parallel to height and width directions of the grinding platform 51, which can facilitate the subsequent mounting and layout of the chamfer grinding components 58 of for corner grinding and the programming of a grinding feeding rate thereof.

Further, the cutting-off and grinding integrated machine further includes first compression cylinders 54 and an end gripping component 510, wherein the first compression cylinders 54 are disposed on one side of the grinding seats 52, driving ends of the first compression cylinders 54 abut against the crystal bar to fix the crystal bar to the grinding seats 52; and the end gripping component 510 includes gripping arms 5101 and a moving mechanism 5102, the moving mechanism 5102 is disposed on one side of the grinding seats 52, two gripping arms 5101 are disposed on two ends of the length direction of each of the grinding seats 52, and the two gripping arms 5101 are matched with the moving mechanism 5102 so as to be close to or away from each other.

It can be known from the above-mentioned description that sides and ends of the crystal bar are respectively abutted by the first compression cylinders 54 and the end gripping component 510, so that the crystal bar is kept fixed during a grinding operation, which guarantees the grinding precision.

Further, the manipulator 61 includes a body 611, a clamping structure 612, and a second compression cylinder 613, the clamping structure 612 includes two opposite clamping arms 6121, the clamping arms 6121 are disposed on two ends of the body 611, and clamping blocks 6122 are rotatably disposed on the clamping arms 6121; and the second compression cylinder 613 is disposed on one side of the body 611, and a driving end of the second compression cylinder 613 is movable in a height direction of the base 53.

It can be known from the above-mentioned description that two ends of the crystal bar are gripped by the clamping arms 6121 and the clamping blocks 6122 of the manipulator 61 so as to be transferred; due to the design of the rotatable clamping blocks 6122, the clamping blocks 6122 can be driven to rotate according to a required inclination angle of the crystal bar when the crystal bar is stored on the inclined grinding seats 52; in order to avoid the situation that the crystal bar cannot be fitted to the grinding seats 52 to affect the subsequent machining because rotation angles of the clamping blocks 6122 are not in place in a transfer process of the crystal bar, the crystal bar transferred by the manipulator 61 is compressed by adopting the second compression cylinder 613, and thus, it is ensured that the crystal bar is accurately fitted to the grinding seats 52.

Further, the cutting-off and grinding integrated machine further includes a calibration component 56, wherein the calibration component 56 includes a tool setting apparatus 561 and a benchmarking block 562, the tool setting apparatus 561 includes a tool setting fixing seat 5611, a chamfer tool setting instrument 5612, and a plane tool setting instrument 5613, the tool setting fixing seat 5611 is disposed on the grinding platform 51, and the chamfer tool setting instrument 5612 and the plane tool setting instrument 5613 are both disposed on the tool setting fixing seat 5611 and are respectively opposite to the chamber grinding components 58 and the plane grinding components 57; each of the plane grinding components 57 includes a benchmarking sensor 571 and a first driving apparatus, and the benchmarking sensor 571 is opposite to the benchmarking block 562; and the first driving apparatus drives the benchmarking sensor 571 to move to the benchmarking block 562.

It can be known from the above-mentioned description that due to the design of the chamfer tool setting instrument 5612 and the plane tool setting instrument 5613 of the tool setting apparatus 561, a tool setting operation can be performed on the chamber grinding components 58 and the plane grinding components 57, and the abrasion loss of the above-mentioned grinding component 5 is determined to control a subsequent machining and feeding rate; due to the layout of the chamfer tool setting instrument 5612 and the plane tool setting instrument 5613 on the tool setting fixing seat 5611, compact layout is achieved; and positions of plane grinding wheels of the plane grinding components 57 are benchmarked and returned to zero by the benchmarking block 562, and the benchmarking sensor 571 abuts against the benchmarking block 562 to determine a position where the plane grinding wheels are returned to zero, then, position detection is performed on a plurality of point locations of the benchmarking sensor 571 on the cutting surface of the crystal bar by moving and matching with the grinding platform 51, and thus, a subsequent machining and grinding amount is determined.

Further, the cutting-off and grinding integrated machine further includes an oilstone component 55, wherein the oilstone component 55 includes chamfer grinding oilstones 551 and plane grinding oilstones 552, and the chamfer grinding oilstones 551 and the plane grinding oilstones 552 are respectively disposed on portions, opposite to the chamfer grinding components 58 and the plane grinding components 57, of the grinding platform 51.

It can be known from the above-mentioned description that the chamfer grinding components 58 and the plane grinding components 57 are ground respectively by means of the chamfer grinding oilstones 551 and the plane grinding oilstones 552, which guarantees the machining precision.

Further, the cutting-off and grinding integrated machine further includes air blowing components, wherein each of the air blowing components is disposed on a lower side of each of the cutting-off component 4 and the grinding component 5, the air blowing component includes an air blower component 7 and a connecting pipe 8, and an end portion of the connecting pipe 8 is connected with the air blower component 7; and a plurality of air outlets are spaced along a length of the connecting pipe 8, and extension lines of orientations of the air outlets are staggered from an extension line of a length direction of the connecting pipe 8.

It can be known from the above-mentioned description that due to the layout of the connecting pipe 8 on the lower sides of the cutting-off component 4 and the grinding component 5 and the design of the plurality of air outlets in the connecting pipe 8, air is uniformly discharged on each portion, and it is impossible that the precision of an actuation mechanism of a machining table is affected by water vapor invasion caused by a pressure difference existing during traditional single-side air blowing in a length direction of the machining table.

Further, the air blowing component further includes a shielding part 101 disposed on an upper side of the connecting pipe 8, and the orientations of the air outlets are opposite to the shielding part 101; the shielding part 101 includes an inclined plate 1011 and a guide plate 1012, the inclined plate 1011 is opposite to the air outlets, the inclined plate 1011 is inclined downwards from the middle of the shielding part 101 to a side of the shielding part 101, and the guide plate 1012 is connected to a side, away from the middle of the shielding part 101, of the inclined plate 1011.

It can be known from the above-mentioned description that by disposing the shielding part 101, on one hand, water vapor or debris on the machining table can be blocked on an outer side of the shielding part 101, and on the other hand, air blown on an inner side can be uniformly dispersed along a breadth of the shielding part 101 after being in contact with the shielding part 101, so that it is ensured that the air pressure is balanced; and by means of inclined layout of the inclined plate 1011, flow directions of discharged air and condensed water vapor can be guided, so that they are rapidly dispersed to two sides, and then, the flow directions thereof are further guided by the guide plate 1012.

Further, the cutting-off and grinding integrated machine further includes a protective component 512, wherein the protective component 512 includes a protective cover 5121 and a second driving apparatus, the protective cover 5121 is rotatably disposed on the grinding platform 51, and the protective cover 5121 covers the calibration component 56; and a driving end of the second driving apparatus is connected with the protective cover 5121.

It can be known from the above-mentioned description that by covering the protective cover 5121 of the protective component 512 on the calibration component 56, the situation that wastes or other foreign matters generated in a machining process are adhered to the calibration component 56 to lead to machining and calibration errors of the chamfer grinding components 58 and the plane grinding components 57 is avoided; and due to the design of the driving end of the second driving apparatus and the rotatable protective cover 5121, the protective cover 5121 is opened during the machining and calibration of the chamfer grinding components 58 and the plane grinding components 57, and the protective cover 5121 is closed in other time, so that the calibration component 56 is shielded for protection.

Further, the feeding component 2 includes a feeding conveyor belt 21 and a first cleaning component, the first cleaning component is disposed on one end of the feeding conveyor belt 21, the first cleaning component includes a first cleaning nozzle 22 and a first cleaning brush 23, the first cleaning nozzle 22 is opposite to the feeding conveyor belt 21, and the first cleaning brush 23 abuts against the feeding conveyor belt 21; the blanking component 3 includes a blanking conveyor belt 31 and a second cleaning component, the second cleaning component is disposed on one end of the blanking conveyor belt 31, the second cleaning component includes a second cleaning nozzle 36 and a second cleaning brush 37, the second cleaning nozzle 36 is opposite to the blanking conveyor belt 31, and the second cleaning brush 37 abuts against the blanking conveyor belt 31; and the transfer component 6 further includes a third cleaning component disposed on the manipulator 61, and the third cleaning component includes a third cleaning nozzle 65 opposite to the to-be-machined crystal bar.

It can be known from the above-mentioned description that the feeding conveyor belt 21 is spray-washed by adopting the first cleaning nozzle 22, and residual wastes on the feeding conveyor belt 21 are further cleared by the first cleaning brush 23, so that the storage of the crystal bar is guaranteed; similarly, wastes on the blanking conveyor belt 31 are also cleared by the second cleaning nozzle 36 and the second cleaning brush 37; and by means of the third cleaning component disposed on the manipulator 61, the crystal bar can be cleaned during gripping and transferring, and thus, the situation that the crystal bar is scratched when being grabbed and gripped due to waste residues on a grabbing surface is avoided.

Further, the machine body 1 includes a mounting base 11, and the cutting-off component 4 and the grinding component 5 are disposed on the mounting base 11; the feeding component 2 includes a feeding conveyor belt 21, the blanking component 3 includes a blanking conveyor belt 31, one end of the feeding conveyor belt 21 is used as a blanking position located between the cutting-off component 4 and the grinding component 5, and the other end thereof is used as a feeding position away from the mounting base 11; one end of the blanking conveyor belt 31 is used as a feeding position located on one side of the grinding component 5, and the other end thereof is used as a blanking position away from the mounting base 11; the feeding component 2 further includes a feeding rack 24, a positioning apparatus 25, and a size detection apparatus 26, the feeding rack 24 is connected to a front side of the mounting base 11, and the feeding conveyor belt 21 is disposed on the feeding rack 24; the positioning apparatus 25 includes a positioning plate 251, a moving plate 252, and a driving cylinder, the positioning plate 251 and the moving plate 252 are respectively disposed on two sides of the feeding conveyor belt 21, the moving plate 252 is movable to the positioning plate 251, and a driving end of the driving cylinder drives and is connected with the moving plate 252; and the size detection apparatus 26 is disposed on the feeding rack 24 and is used for detecting a size of the crystal bar.

It can be known from the above-mentioned description that due to the design that the feeding conveyor belt 21 and the blanking conveyor belt 31 are away from one side of the mounting base 11, the space on one side of the mounting base 11 is reasonably utilized, and a sufficient transfer space can be provided for facilitating feeding the to-be-machined crystal bar and blanking the processed crystal bar; the feeding rack 24 is used as a supporting structure of the feeding conveyor belt 21 away from a portion of the mounting base 11; and during feeding, the to-be-machined crystal bar is transferred to the feeding position of the feeding conveyor belt 21, at the moment, by matching the moving plate 252 of the positioning apparatus 25 with the driving cylinder, the crystal bar is pushed to the positioning plate 251 and is compressed by the moving plate 252 so as to be fixed, and then, size detection is performed by the size detection apparatus 26.

Further, the size detection apparatus 26 includes a width detection apparatus, a thickness detection apparatus, and a length detection apparatus, the width detection apparatus includes a first contact sensor 261 and a first driving motor, the first contact sensor 261 is disposed on the feeding rack 24 on the same side as the moving plate 252, and the first driving motor drives the first contact sensor 261 to move to the positioning plate 251; the thickness detection apparatus includes a second contact sensor 262 and a second driving motor, the second contact sensor 262 is disposed above the feeding conveyor belt 21, and the second driving motor drives the second contact sensor 262 to move to the feeding conveyor belt 21; and the length detection apparatus includes through-beam photoelectric sensors 263 respectively disposed on two sides of the feeding conveyor belt 21.

It can be known from the above-mentioned description that during size detection, the first contact sensor 261 is pushed to the side of the crystal bar by the first driving motor so as to detect the width of the crystal bar; the second contact sensor 262 is pushed to the top of the crystal bar by the second driving motor so as to detect the thickness of the crystal bar; and head and tail end portions of the crystal bar are conveyed by the feeding conveyor belt 21 to sequentially pass through the through-beam photoelectric sensors 263, and thus, the length of the crystal bar is detected.

A control method for a cutting-off and grinding integrated machine is applied to any one of the above-mentioned cutting-off and grinding integrated machines, and includes the following steps: after a crystal bar is placed on the feeding component 2, the feeding component 2 moves in the length direction of the machine body 1 to convey the crystal bar to the blanking position of the feeding component 2; then, the manipulator 61 transversely moves to the blanking position of the feeding component 2 in the width direction of the machine body 1 to grab the crystal bar, then, the manipulator 61 transversely moves to the machining position of the cutting-off component 4 again, and a cutting-off process is performed by the cutting-off component 4; after the cutting-off process is completed, the manipulator 61 grabs the cut-off crystal bar and transversely moves to the machining position of the grinding component 5, and a chamfer grinding process and a plane grinding process are sequentially performed on the crystal bar by the chamfer grinding components 58 and the plane grinding components 57; and after the chamfer grinding process and the plane grinding process are completed, the manipulator 61 grabs the ground crystal bar and transversely moves to the feeding position of the blanking component 3, and the crystal bar is conveyed out of the machine body 1 by the blanking component 3.

It can be known from the above-mentioned description that the manipulator 61 transversely moves to grab the crystal bar and is respectively matched with the feeding component 2, the cutting-off component 4, the grinding component 5 and the blanking component 3 to complete cutting-off and grinding operations. By controlling the transverse movement of the manipulator 61, the structure can be simplified, a volume of a device can be reduced, the control stability can be improved, and it is also convenient to perform later maintenance operations.

Refer to FIG. 1 to FIG. 26, in some embodiments, a cutting-off and grinding integrated machine includes a machine body 1, a feeding component 2, a blanking component 3, a cutting-off component 4, a grinding component 5, and a transfer component 6.

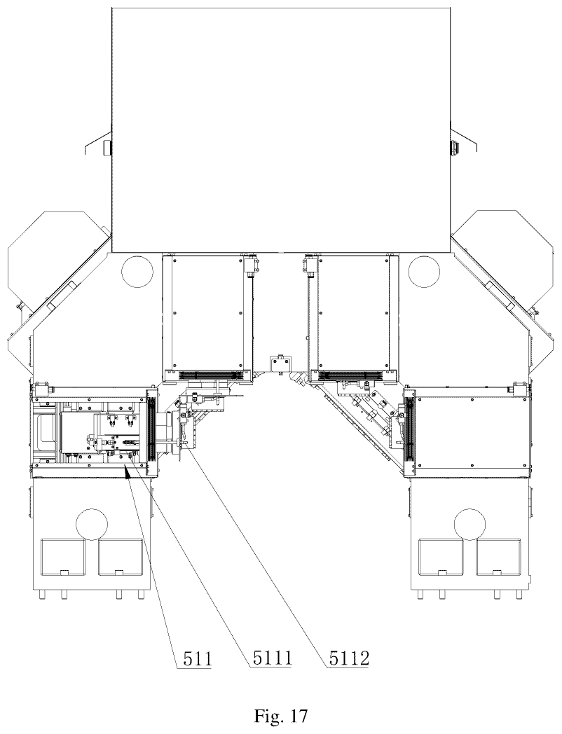

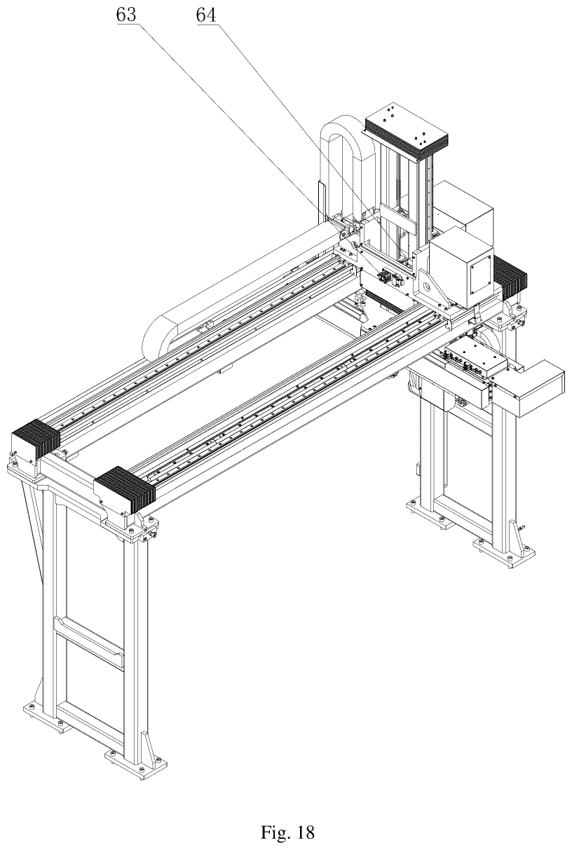

As shown in FIG. 1, the cutting-off component 4, the feeding component 2, the grinding component 5 and the blanking component 3 are juxtaposed in the machine body 1 in a width direction of the machine body 1; the grinding component 5 includes plane grinding components 57, chamfer grinding components 58, a grinding platform 51, an oilstone component 55, a calibration component 56, a protective component 512, and an oilstone loss detection component 511, wherein the chamfer grinding components 58 and the plane grinding components 57 are integrally disposed, and the feeding component 2 and the blanking component 3 are both movable in a length direction of the machine body 1; as shown in FIG. 18, the transfer component 6 includes a manipulator 61, a moving frame 62, and an anti-falling component, wherein the manipulator 61 is movable in the width and height directions of the machine body 1, specifically, the moving frame 62 is disposed above the machine body 1, a length direction of the moving frame 62 is perpendicular to a length direction of the machine body 1, the manipulator 61 is movably matched with the moving frame 62, a connecting rack is connected between the manipulator 61 and the moving frame 62, the connecting rack is movably disposed in a length direction of the moving frame 62, and the manipulator 61 is disposed on the connecting rack and is movable along the height of the machine body 1; the anti-falling component includes an anti-falling cylinder 63 and an anti-falling block 64, the anti-falling block 64 is disposed on the manipulator 61, the anti-falling cylinder 63 is disposed on the connecting rack, and a driving end of the anti-falling cylinder 63 moves to the anti-falling block 64 and abuts against a lower end of the anti-falling block 64; the manipulator 61 is provided with a rotating structure, so that the grabbed crystal bar can rotate; a blanking position of the feeding component 2, a feeding position of the blanking component 3 and machining positions of the cutting-off component 4 and the grinding component 5 are all located on a moving path of the manipulator 61; and the plane grinding components 57 and the chamfer grinding components 58 are disposed on a side, corresponding to the length direction of the machine body 1, of the moving frame 62.

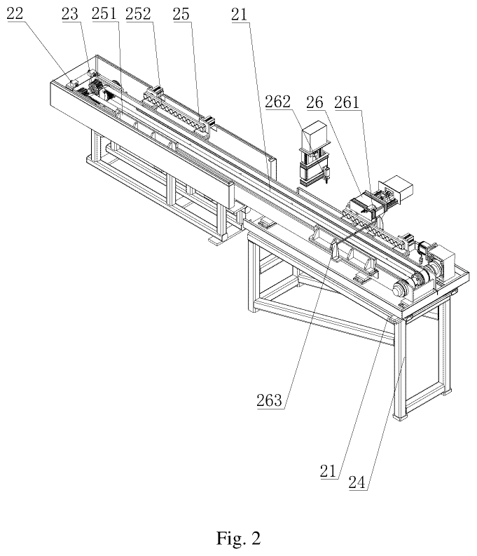

As shown in FIG. 2, the feeding component 2 includes a feeding rack 24, a positioning apparatus 25, a size detection apparatus 26, a feeding conveyor belt 21, and a first cleaning component, one end of the feeding conveyor belt 21 is used as a blanking position located between the cutting-off component 4 and the grinding component 5, and the other end thereof is used as a feeding position away from the mounting base 11; the feeding rack 24 is connected to a front side of the mounting base 11, and the feeding conveyor belt 21 is disposed on the feeding rack 24; the positioning apparatus 25 includes a positioning plate 251, a moving plate 252, and a driving cylinder, the positioning plate 251 and the moving plate 252 are respectively disposed on two sides of the feeding conveyor belt 21, the moving plate 252 is movable to the positioning plate 251, and a driving end of the driving cylinder drives and is connected with the moving plate 252; and the size detection apparatus 26 is disposed on the feeding rack 24 and is used for detecting a size of the crystal bar.

In some embodiments, the size detection apparatus 26 includes a width detection apparatus, a thickness detection apparatus, and a length detection apparatus, the width detection apparatus includes a first contact sensor 261 and a first driving motor, the first contact sensor 261 is disposed on the feeding rack 24 on the same side as the moving plate 252, and the first driving motor drives the first contact sensor 261 to move to the positioning plate 251; the thickness detection apparatus includes a second contact sensor 262 and a second driving motor, the second contact sensor 262 is disposed above the feeding conveyor belt 21, and the second driving motor drives the second contact sensor 262 to move to the feeding conveyor belt 21; and the length detection apparatus includes through-beam photoelectric sensors 263 respectively disposed on two sides of the feeding conveyor belt 21.

Two groups of positioning apparatuses 25 are disposed, one group of positioning apparatus 25 is disposed on the feeding position of the feeding conveyor belt 21, and the other group of positioning apparatus 25 is disposed on the blanking position of the feeding conveyor belt 21.

A first cleaning component is disposed on one end of the feeding conveyor belt 21, the first cleaning component includes a first cleaning nozzle 22 and a first cleaning brush 23, the first cleaning nozzle 22 is opposite to the feeding conveyor belt 21, and the first cleaning brush 23 abuts against the feeding conveyor belt 21; and

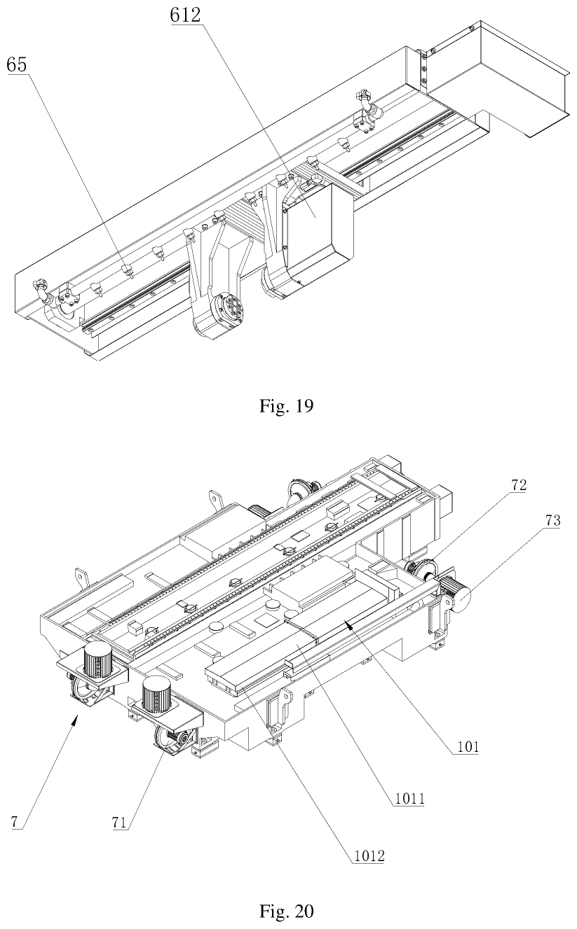

as shown in FIG. 19, the transfer component 6 further includes a third cleaning component disposed on the manipulator 61, and the third cleaning component includes a third cleaning nozzle 65 opposite to a to-be-machined crystal bar.

As shown in FIG. 4 to FIG. 6, the cutting-off component 4 includes a rack 45, a cutting-off apparatus 42, loading abutments 41, an adjusting component 43, and a compression component 44, the loading abutments 41 are disposed on two sides of a length direction of the rack 45, the adjusting component 43 is disposed between the two loading abutments 41, and the adjusting component 43 drives the loading abutments 41 to move face to face or back to back; each of the loading abutments 41 is provided with a storage portion 4111 and a positioning portion 4113, the storage position 4111 abuts against the bottom of the crystal bar, and the positioning portion 4113 abuts against the side of the crystal bar; the opposite sides of the two storage portions 4111 are flat and straight surfaces between which a cutting gap extending in the length direction of the rack 45 is formed; the cutting-off apparatus 42 is movably disposed in the length direction of the rack 45 and cuts the crystal bar through the cutting gap; and the compression component 44 is disposed above the loading abutments 41 and abuts against the storage portions 4111 to compress the crystal bar on the storage portions 4111.

In some embodiments, the adjusting component 43 includes a leading screw, slide blocks, and slide rails, two ends of the leading screw are respectively provided with a first screw thread in a first rotation direction and a second screw thread of which the rotation direction is opposite to the first rotation direction, and two ends of the leading screw are respectively in threaded connection with the slide blocks; and the bottoms of each of the two loading abutments 41 is connected with one of the slide blocks. The rotation of the leading screw is controlled by a driving apparatus, so that the slide blocks matched with the corresponding first screw thread and second screw thread move face to face or back to back, and the slide blocks drive the corresponding loading abutments 41 to move at the same time; and meanwhile, lower ends of the loading abutments 41 are movably matched with the slide rails to perform movement guide.

In some embodiments, the adjusting component 43 can also adjust a distance between the two loading abutments 41 in a form of air cylinder pushing.

The compression component 44 is fixedly disposed on the loading abutments 41. In some embodiments, each of the loading abutments 41 is provided with a first mounting seat 413 in which a mounting space allowing the compression component 44 to ascend or descend is disposed, the compression component 44 includes a driving cylinder, a connecting plate 441, and a compression head 442, a driving end of the driving cylinder drives the connecting plate 441 to move up and down, the connecting plate protrudes to face the loading abutment 41 on the other side, and the crystal bar on the storage portion 4111 of the loading abutment 41 is compressed and fixed by the compression head 442. One side of the first mounting seat 413 and the positioning portion 4113 of the loading abutment 41 abut against the side of the stored crystal bar at the same time.

The top of the crystal bar is abutted and fixed by the above-mentioned compression component 44 after the crystal bar is stored on the loading abutment 41 and adjusted by the adjusting component 43 so as to be gripped and fixed.

In some embodiments, the compression component 44 can also be disposed on the rack 45, a supporting seat extends from the bottom of the rack 45 to a height position of the loading abutment 41 or a supporting seat extends from the top of the rack 45 to the height position of the loading abutment 41 to compress the crystal bar on the loading abutment 41 up and down.

A positioning cylinder 414 movable to the positioning portion 4113 of the other loading abutment 41 can be additionally disposed on the loading abutment 41 and be used as an auxiliary positioning structure 411 to be matched with the adjusting component 43 so as to achieve rough adjustment and fine adjustment of the distance between the two loading abutments 41.

The storage portion 4111 and the positioning portion 4113 are provided with a protective part abutting against the crystal bar. The protective part is a cushion block or a backing plate disposed on the storage portion 4111 and the positioning portion 4113 and used as a plane for storing the crystal bar or a glue-coated structure packed on the storage portion 4111 and the positioning portion 4113.

In some embodiments, a plurality of cushion blocks 415 are spaced on the storage portion 4111 and the positioning portion 4113; a plurality of storage grooves 416 are spaced in a length direction of the storage portion 4111, and length directions of the storage grooves 416 are parallel to movement directions of the loading abutments 41; and the cushion blocks 415 are movably adjusted along the storage grooves 416. by adopting the cushion blocks 415, the storage of the crystal bar can be buffered, and at the same time, scratches caused by direct contact friction between the crystal bar and the loading abutments 41 can be avoided; and in terms of the design of matching with the size of the crystal bar, appropriate positions of the cushion blocks 415 can be adjusted according to the size of the crystal bar by moving and adjusting the cushion blocks 415 in the storage grooves 416, so that it is ensured that the stress is stable during storage.

In some embodiments, each of the loading abutments 41 includes a positioning structure 411 and a reinforcing structure 412, the positioning structure 411 faces the rack 45 and is L-shaped, a horizontal portion of the positioning structure 411 is the storage portion 4111, and a vertical portion of the positioning structure 411 is the positioning portion 4113; the reinforcing structure 412 is connected to a side, away from the rack 45, of the positioning portion 4113; and the reinforcing structure 412 includes a plurality of reinforcing rib plates connected with the vertical portion of the positioning structure 411. By means of the design that the horizontal portion and the vertical portion of the L-shaped positioning structure 411 are respectively used as tool structures for connecting the bottom of the crystal bar and gripping the side thereof and the positioning structure 411 is away from the reinforcing rib plates of the reinforcing structure 412 on one side of the rack 45, the material consumption is reduced while the structural strength is guaranteed.

In some embodiments, grabbing portions are disposed on two ends, corresponding to the length direction of the crystal bar, of the manipulator 61, and the manipulator 61 is movable in the movement directions of the loading abutments 41; the adjusting component 43 is matched with the manipulator 61 so that the cut-off crystal bar is separated and is grabbed one by one by the manipulator 61; and the manipulator 61 used as a structure for grabbing and transferring the crystal bar is matched with the adjusting component 43 to separate the cut-off crystal bar on the loading abutments 41 so that it is convenient for the manipulator 61 to grab the crystal bar.

As shown in FIG. 1, in some embodiments, the cutting-off apparatus 42 includes a mounting rack 421, a cutting wheel system 422, and a cutting wire saw 423, the cutting wheel system 422 is mounted on the mounting rack 421, the cutting wire saw 423 is wound on the cutting wheel system 422, and a distance of two adjacent segments of the cutting wire saw 423 in a cutting direction is greater than a length of the crystal bar. The mounting rack 421 of the cutting-off apparatus 42 is movably matched with the rack 45, during a cutting-off operation, the driving apparatus drives the mounting rack 421 to move in the length direction of the rack 45 so as to be close to the crystal bar that has been fixed on the loading abutments 41, and the cutting wheel system 422 and the cutting wire saw 423 are matched to cut the crystal bar; and under the design that lengths of wire saw portions on two adjacent ends of the cutting wire saw 423 are matched with the length of the crystal bar, only one segment of cutting wire saw 423 can be kept to partially enter the cutting gap for cutting during operations, and thus, the situation that a plurality of segments of cutting wire saw 423 partially enter the cutting gap at the same time and spring due to spraying in a subsequent wire withdrawing process to scratch the crystal bar is avoided.

In some embodiments, the cutting wheel system 422 is of a four-wheel-system structure, and the cutting wire saw 423 is wound thereby forms a rectangular structure. Two groups of cutting wheels spaced up and down are disposed on portions, close to a front side of the mounting rack 421, of the cutting wheel system 422, and two groups of cutting wheels spaced up and down are disposed on portions close to a rear side of the mounting rack 421; and a spacing between a portion, on the front side of the mounting rack 421, of the wound cutting wire saw 423 and a portion on the rear side of the mounting rack 421 is greater than the length of the crystal bar. For the four-wheel-system structure, a distance between two adjacent segments of the cutting wire saw 423 can be adjusted by adjusting the cutting wheels close to a front side of the mounting rack 421 and a rear side of the mounting rack 421, and then, during wire withdrawing, the situation that the plurality of segments of cutting wire saw 423 partially need to pass through the cutting gap to spring in a process such as spraying so as to scratch the crystal bar can be avoided by means of the design of the cutting wire saw 423 in different crystal bar cutting processes. If the cutting wheel system 422 of the conventional four-wheel-system structure is directly applied to a traditional cutting-off apparatus 42, the plurality of segments of cutting wire saw 423 will partially enter the cutting gap to spring under an external action so as to scratch the crystal bar in a cutting process, and the cutting wire saw 423 usually needs to be sprayed for removing debris after withdrawing out of the cutting gap as a whole, which leads to the design of an overlong size of a device.

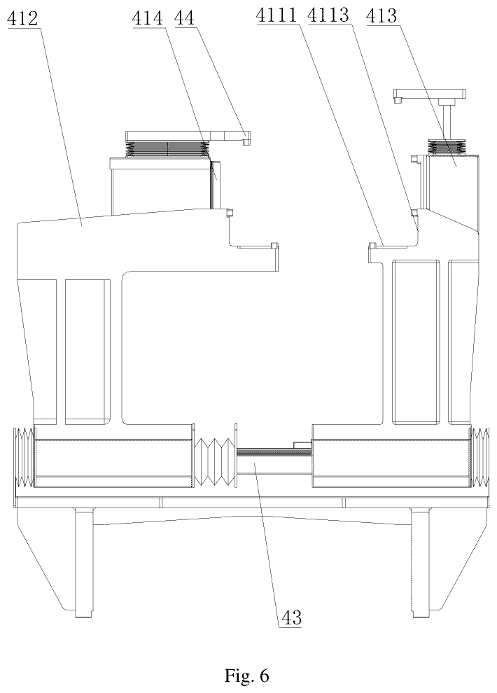

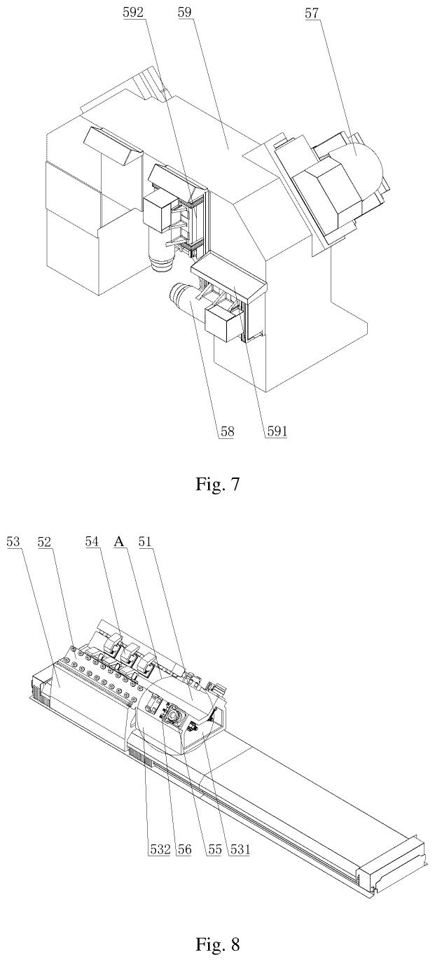

As shown in FIG. 7 to FIG. 12, the grinding component 5 includes a portal frame 59, at least two sets of grinding wheels symmetrically disposed on two sides of the portal frame 59, and a grinding platform 51. In the present embodiment, two sets of grinding wheels are provided; the grinding wheels include chamfer grinding components 58 and plane grinding components 57, the chamfer grinding components 58 and the plane grinding components 57 are respectively disposed on front and rear sides of the portal frame 59, and each set of grinding wheels at least includes two groups of chamfer grinding components 58. In some embodiments, each set of grinding wheels includes two groups of chamfer grinding components 58.

The portal frame 59 is provided with a rinsing component. By means of the rinsing of the rinsing component in a grinding process, residual wastes on the crystal bar and the grinding wheels can be cleaned, and the grinding wheels can be cooled and heat-radiated; the downside of the portal frame 59 is used as a machining position for grinding the crystal bar; a first slide rail and a second slide rail are respectively disposed on mounting portions of the chamfer grinding components 58 and the plane grinding components 57 on the portal frame 59, and the first slide rail and the second slide rail both extend to the machining position for grinding the crystal bar; and the chamfer grinding components 58 and the plane grinding components 57 are movably connected with the first slide rail and the second slide rail, respectively.

For the layout of the two groups of chamfer grinding components 58 of each set of grinding wheels, the portal frame 59 includes a horizontal frame 591 and vertical frames 592 located on two sides of the horizontal frame 591 and perpendicular to the horizontal frame 591; and two groups of chamfer grinding components 58 of one set of grinding wheels are respectively disposed on the horizontal frame 591 and the vertical frames 592.

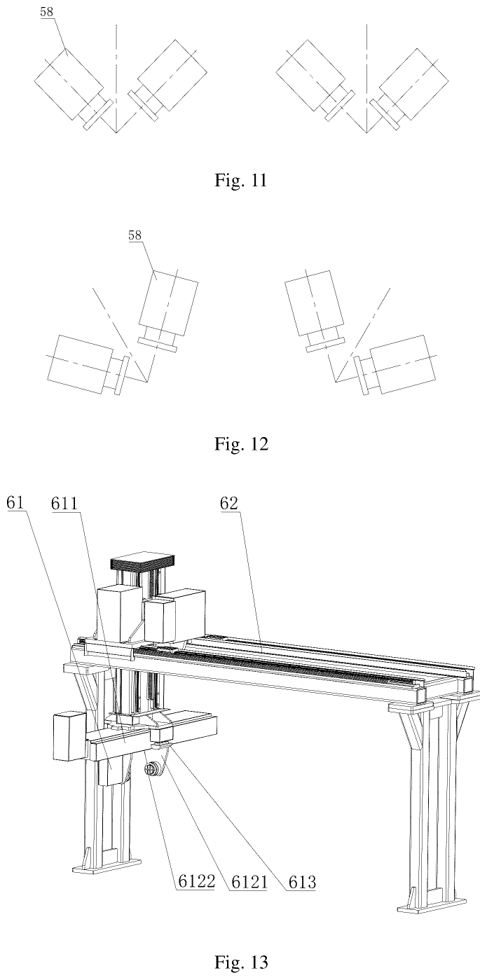

By comparing FIG. 10, FIG. 11 and FIG. 12, FIG. 10, FIG. 11 and FIG. 12 respectively correspond to two situations that projections of axes (angular bisectors of included angles formed by intersection of extension lines of axes of two groups of chamfer grinding components 58 in the figure are axes of the corresponding plane grinding components 57) of the plane grinding components 57 of two sets of symmetric grinding wheels on an end surface of a front side of the portal frame 59 are perpendicular and not perpendicular, by which it can be seen that the chamfer grinding components 58 corresponding to the situation that the axes are not perpendicular can be obliquely disposed in a non-horizontal or perpendicular direction in FIG. 11 and FIG. 12; and preferably, by adopting the layout of the chamfer grinding components 58 shown in FIG. 11 and the design of the grinding component 5 under the situation that the axes of the corresponding plane grinding components 57 are parallel, sizes of a device in width and height directions can be reduced, and space can be provided for the layout of other mechanisms, so that the entirety is more compact.

The grinding platform 51 is movable in a thickness direction of the portal frame 59, the grinding platform 51 is provided with inclined grinding tables corresponding to the left and the right of the portal frame 59, a to-be-machined crystal bar is stored on the grinding tables, the grinding tables are parallel to a cutting surface of the to-be-machined crystal bar, the plane grinding components 57 are opposite to the cutting surface of the crystal bar, and the chamfer grinding components 58 are opposite to corner structures on two sides of the cutting surface of the crystal bar.

As shown in FIG. 8, in some embodiments, the grinding platform 51 includes grinding seats 52, a base 53, and a second mounting seat 532, the grinding seats 52 are respectively disposed on two sides of the base 53, the grinding seats 52 are obliquely disposed, and the to-be-machined crystal bar is fixed to the grinding seats 52. In the present embodiment, an included angle between a surface, to which the crystal bar is fixed, of each of the grinding seats 52 and an upper end surface of the base 53 is 45 degrees.

In some embodiments, the two grinding seats 52 are connected to form an M shape; and a hollow portion 531 is disposed in the middle of the base 53 and can be used for mounting components on the grinding seats 52, with a compression cylinder mounted on each of the grinding seats 52 as an example, a driving motor of the compression cylinder can be mounted in the hollow portion 531.

The second mounting seat 532 is disposed on a tail end of the base 53, and the second mounting seat and the grinding seats 52 are obliquely disposed on two sides of the base 53. The second mounting seat 532 can be used for mounting fitting components of a grinding tool, for example, a tool setting component, a benchmarking component and an oilstone component are all mounted on the second mounting seat 532.

The grinding seats 52 are provided with L-shaped storage grooves for storing the crystal bar, and cushion blocks are disposed in the storage grooves 416; as shown in FIG. 22, the grinding seats 52 are provided with first compression cylinders 54 and an end gripping component 510, the first compression cylinders 54 are disposed on one side of the grinding seats 52, driving ends of the first compression cylinders 54 abut against the crystal bar to fix the crystal bar to the grinding seats 52; and

in some embodiments, convex abutting edges are disposed on one side of the length directions of the grinding seats 52, and compression directions of the first compression cylinders 54 are opposite to the convex abutting edges.

In some embodiments, two groups of first compression cylinders 54 are adopted, and the two first compression cylinders 54 are respectively disposed on two sides of the length directions of the grinding seats 52.

In some embodiments, one end of each of the first compression cylinders 54 can be disposed in the hollow portion 531 of the base 53.

The end gripping component 510 includes gripping arms 5101 and a moving mechanism 5102, the moving mechanism 5102 is disposed on one side of the grinding seats 52, two gripping arms 5101 are disposed on two ends of the length direction of each of the grinding seats 52, and the two gripping arms 5101 are matched with the moving mechanism 5102 so as to be close to or away from each other.

In some embodiments, the grinding seats 52 are provided with two limiting structures respectively corresponding to the shortest spacing and the longest spacing between the two corresponding gripping arms 5101. The moving mechanism 5102 adopts a combination of a two-way leading screw and a motor, and the gripping arms 5101 are connected to two ends of the two-way leading screw so as to be close to or away from each other under the driving of the motor.

As shown in FIG. 13, the manipulator 61 is movable in the length direction of the moving frame 62 and can grab and transfer the cut crystal bar on the cutting-off component 4 to the grinding platform 51; the manipulator 61 is movable in a height direction of the base 53; and the manipulator 61 includes a body 611 and a clamping structure 612, the clamping structure 612 includes two opposite clamping arms 6121, the clamping arms 6121 are disposed on two ends of the body 611, and clamping blocks 6122 are rotatably disposed on the clamping arms 6121. A second compression cylinder 613 is disposed on one side of the body 611, and a driving end of the second compression cylinder 613 is movable in the height direction of the base 53.

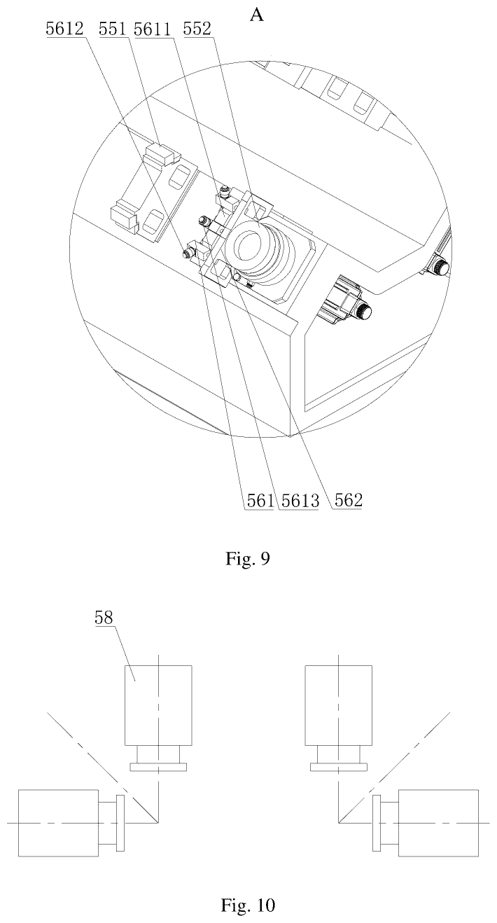

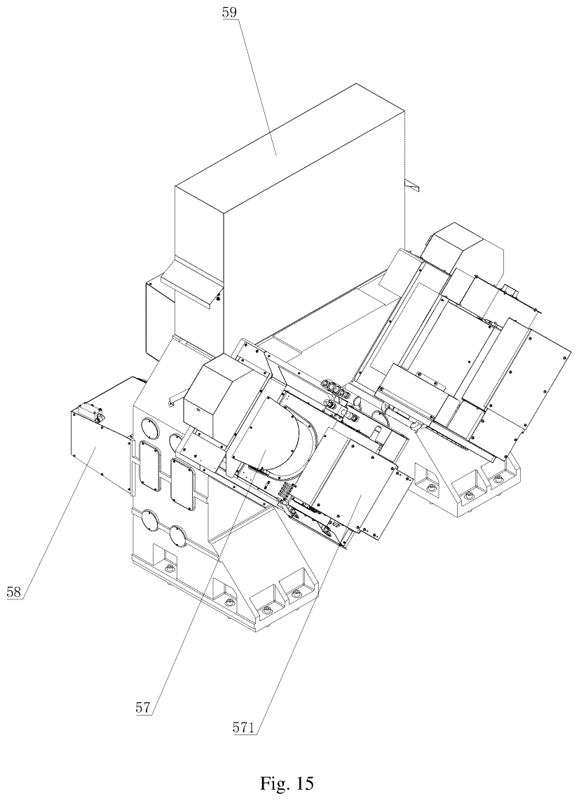

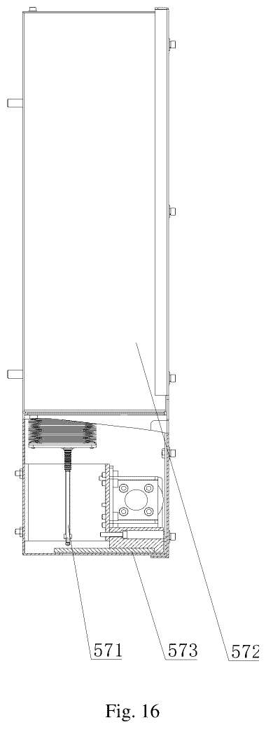

As shown in FIG. 8 to FIG. 9, the calibration component 56 includes a tool setting apparatus 561 and a benchmarking block 562, the tool setting apparatus 561 includes a tool setting fixing seat 6511, a chamfer tool setting instrument 5612, and a plane tool setting instrument 5613, the tool setting fixing seat 5611 is disposed on the grinding platform 51, and the chamfer tool setting instrument 5612 and the plane tool setting instrument 5613 are both disposed on the tool setting fixing seat 5611 and are respectively opposite to the chamber grinding components 58 and the plane grinding components 57; as shown in FIG. 15 and FIG. 16, each of the plane grinding components 57 includes a benchmarking shell 572, a benchmarking slide plate 573, a benchmarking sensor 571, and a first driving apparatus, the benchmarking shell 572 is disposed on the portal frame 59 and is provided with an opening corresponding to the benchmarking block 562, the movable benchmarking slide plate 573 is disposed in the opening, the benchmarking sensor 571 is disposed in the benchmarking shell 572, and the benchmarking sensor 571 is opposite to the benchmarking block 562; and the first driving apparatus drives the benchmarking sensor 571 to move to the benchmarking block 562. The benchmarking slide plate 573 seals the opening of the benchmarking shell 572 when not performing a benchmarking operation so as to avoid water vapor or flying chip invasion.

In some embodiments, the tool setting apparatus 561 and the benchmarking block 562 are disposed in the same area of the grinding platform 51.

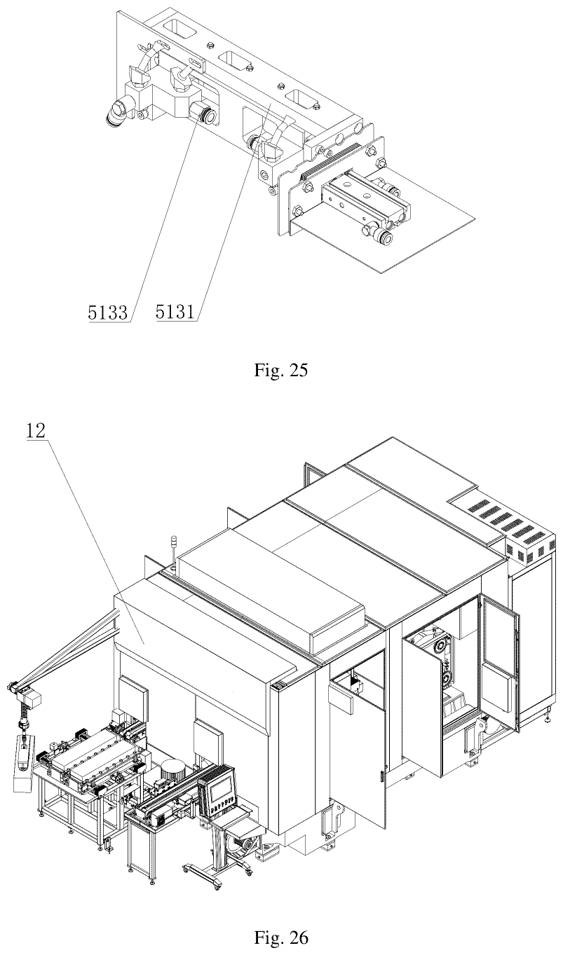

In some embodiments, as shown in FIG. 24 and FIG. 25, a benchmarking cleaning component 513 is further disposed on one side of the benchmarking block 562, the benchmarking cleaning component 513 includes a pushing cylinder, a pushing frame 5131, a pushing brush 5132, and an air blowing pipe 5133, the pushing cylinder drives the pushing frame 5131 to move in a length direction of the benchmarking block 562, the pushing frame 5131 is provided with the pushing brush 5132 abutting against the benchmarking block 562, and the benchmarking block 562 is scrapped and brushed by the pushing brush 5132 over and over again so as to be kept clean; and at the same time, the pushing frame 5131 is provided with the air blowing pipe 5133 capable of achieving blow-drying, so that water vapor and flying chip adhesion during machining is avoided.

The oilstone component 55 includes chamfer grinding oilstones 551 and plane grinding oilstones 552, and the chamfer grinding oilstones 551 and the plane grinding oilstones 552 are respectively disposed on portions, opposite to the chamfer grinding components 58 and the plane grinding components 57, of the grinding platform 51. The plane grinding oilstones 552 are rotatably disposed on the grinding platform 51. By means of the design of the rotatable plane grinding oilstones 552, the plane grinding oilstones 552 can be matched with the rotation of plane grinding wheels of the plane grinding components 57 to reversely rotate, so that the grinding for the plane grinding wheels is accelerated, and the operation efficiency is increased.

In some embodiments, as shown in FIG. 17, the oilstone loss detection component 511 is movable to the oilstone component 55. The oilstone loss detection component 511 includes a movable slide rail 5111, a driving cylinder and a detection sensor 5112 that are disposed at the chamfer grinding components 58, and the driving cylinder drives the detection sensor 5112 to move to the chamfer grinding oilstones 551 along the movable slide rail 5111.

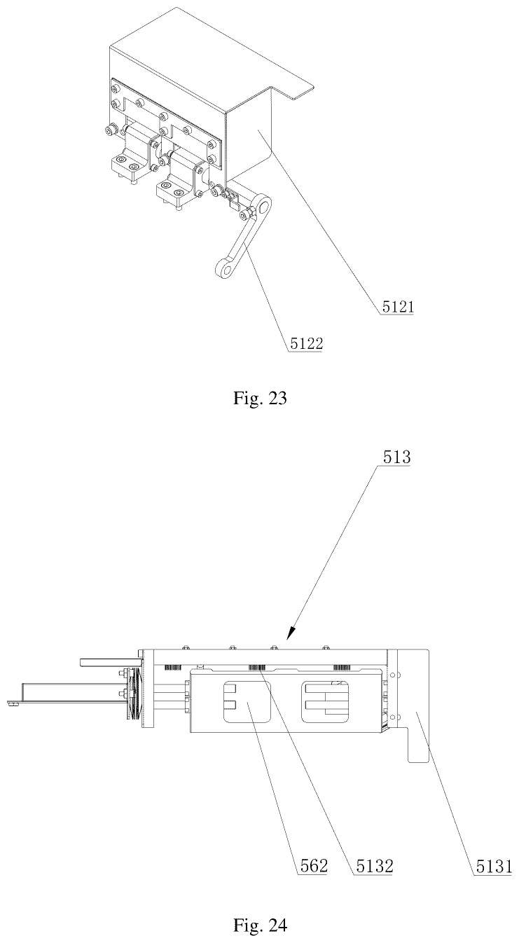

As shown in FIG. 22 and FIG. 23, the protective component 512 includes a protective cover 5121, a driving linkage 5122, and a second driving apparatus, the protective cover 5121 is rotatably disposed on the grinding platform 51, and the protective cover 5121 covers the calibration component 56; a driving end of the second driving apparatus is connected with the protective cover 5121 by the driving linkage 5122; and by disposing the protective component 512, the tool setting apparatus 561, and the benchmarking block 562, the tool setting apparatus 561 and the benchmarking block 562 can be unitedly protected and shielded by the protective cover 5121 so that wastes or foreign matters are prevented from being adhered to the calibration component 56.

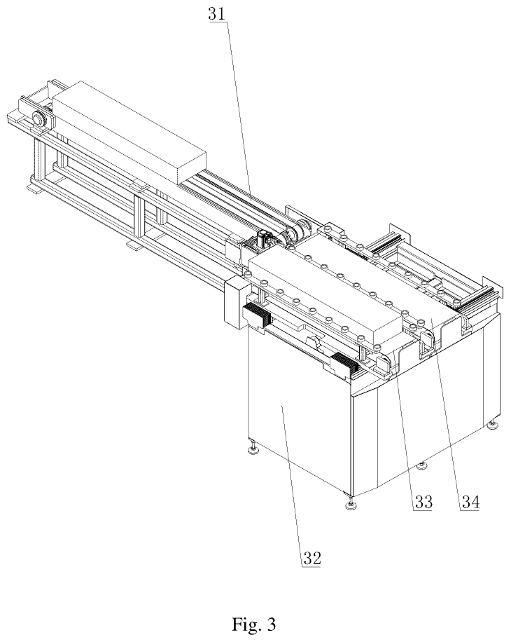

As shown in FIG. 3, the blanking component 3 includes a blanking conveyor belt 31, a guide frame 35, a blanking rack 32, and a second cleaning component; and one end of the blanking conveyor belt 31 is used as a feeding position located on one side of the grinding component 5, and the other end thereof is used as a blanking position away from the mounting base 11. The blanking rack 32 is connected to a front side of the mounting base 11; the blanking rack 32 is provided with a first storage rack 33 and a second storage rack 34 that move in a width direction of the blanking conveyor belt 31; and the blanking conveyor belt 31 is opposite to one of the first storage rack 33 or the second storage rack 34. The guide frame 35 is disposed on the mounting base 11, and the blanking conveyor belt 31 passes through the guide frame 35; and a space allowing the crystal bar to pass through is formed between the blanking conveyor belt 31 and the guide frame 35.

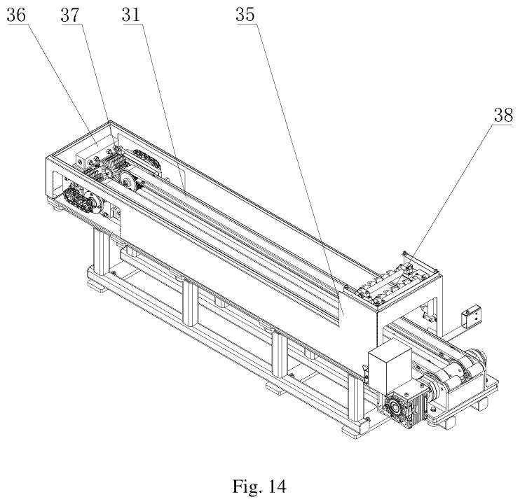

As shown in FIG. 14, the second cleaning component is disposed on one end of the blanking conveyor belt 31, the second cleaning component includes a second cleaning nozzle 36, a second cleaning brush 37, and a blow-drying component 38, the second cleaning nozzle 36 is opposite to the blanking conveyor belt 31, the second cleaning brush 37 abuts against the blanking conveyor belt 31, and the blow-drying component 38 is disposed on the guide frame 35.

In some embodiments, baffles are disposed on two sides of each of the feeding conveyor belt 21 and the blanking conveyor belt 31 to prevent waste generated during machining for other processes from falling on the feeding conveyor belt 21 and the blanking conveyor belt 31.

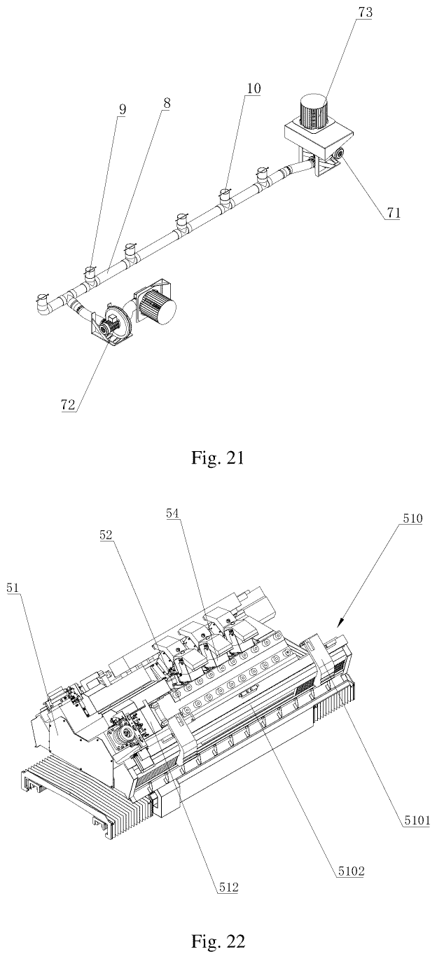

In some embodiments, as shown in FIG. 20 and FIG. 21, an air blowing component is disposed on a lower side of each of the cutting-off component 4 and the grinding component 5, the air blowing component includes an air blower component 7 and a connecting pipe 8, and an end portion of the connecting pipe 8 is connected with the air blower component 7; and a plurality of air outlets are spaced along a length of the connecting pipe 8, and extension lines of orientations of the air outlets are staggered from an extension line of a length direction of the connecting pipe 8.

The air blowing component further includes a shielding part 101 disposed on an upper side of the connecting pipe 8, and the orientations of the air outlets are opposite to the shielding part 101; the shielding part 101 includes an inclined plate 1011 and a guide plate 1012, the inclined plate 1011 is opposite to the air outlets, the inclined plate 1011 is inclined downwards from the middle of the shielding part 101 to a side of the shielding part 101, and the guide plate 1012 is connected to a side, away from the middle of the shielding part 101, of the inclined plate 1011.

In some embodiments, the air outlets of the connecting pipe 8 are connected with air outlet pipes 9. The air outlet pipes 9 are provided with engaging parts 10, portions, corresponding to the cutting-off component 4 and the grinding component 5, of the machine body 1 are provided with mounting holes corresponding to the air outlet pipes 9, and the engaging parts 10 are engaged with the mounting holes.

Through holes passing through the air outlet pipes 9 are disposed in ends, away from the connecting pipe 8, of the air outlet pipes 9 in a direction perpendicular to length directions of the air outlet pipes 9, and the engaging parts 10 penetrate in the through holes, and two ends thereof protrude out of sides of the air outlet pipes 9.

The air blower component 7 includes a first air blower 71, a second air blower 72, a filter 73, and a drying apparatus, wherein the first air blower 71 and the second air blower 72 are respectively connected to two ends of the connecting pipe 8. Both of the first air blower 71 and the second air blower 72 are sequentially connected with the drying apparatus and the filter 73. Specifically, as shown in FIG. 26, the machine body 1 includes an external protective cover 12 by which the machine body 1 is covered as a whole to prevent water vapor and debris from flying off, and the filter 73 is disposed on an outer side of the external protective cover 12 of the machine body 1.

In some embodiments, a control method for a cutting-off and grinding integrated machine is applied to the cutting-off and grinding integrated machine in the above-mentioned embodiment, and includes the following steps: after a crystal bar is placed on the feeding component 2, the feeding component 2 moves in the length direction of the machine body 1 to convey the crystal bar to the blanking position of the feeding component 2; then, the manipulator 61 transversely moves to the blanking position of the feeding component 2 in the width direction of the machine body 1 to grab the crystal bar, then, the manipulator 61 transversely moves to the machining position of the cutting-off component 4 again, and a cutting-off process is performed by the cutting-off component 4; after the cutting-off process is completed, the manipulator 61 grabs the cut-off crystal bar and transversely moves to the machining position of the grinding component 5, and a chamfer grinding process and a plane grinding process are sequentially performed on the crystal bar by the chamfer grinding components 58 and the plane grinding components 57; and after the chamfer grinding process and the plane grinding process are completed, the manipulator 61 grabs the ground crystal bar and transversely moves to the feeding position of the blanking component 3, and the crystal bar is conveyed out of the machine body 1 by the blanking component 3.

The embodiments described herein include one or more modes known by the applicant and used for implementing the claimed subject. Of course, variations of these embodiments will be apparent for those of ordinary skill in the art after they read the above-mentioned description. It is expected by the applicant that the skilled in the art properly adopts such variations, and the applicant wants to implement the claimed subject in a way different from the way specifically described herein. Therefore, the claimed subject includes all modifications and equivalents of a subject in the appended claims, such as a subject allowed by an applicable law. Moreover, any combination of the above-mentioned elements in all their possible variations is included unless otherwise indicated herein or otherwise clearly contradicted with the context.

What is claimed is:

1. A cutting-off and grinding integrated machine, comprising a machine body, a feeding component, a blanking component, a cutting-off component, a grinding component, and a transfer component, wherein,
the cutting-off component, the feeding component, the grinding component and the blanking component are juxtaposed in the machine body in a width direction of the machine body;
the grinding component comprises plane grinding components and chamfer grinding components, the chamfer grinding components and the plane grinding components are integrally disposed, and the feeding component and the blanking component are both movable in a length direction of the machine body; and
the transfer component comprises a manipulator movable in the width direction and a height direction of the machine body, and a blanking position of the feeding component, a feeding position of the blanking component and machining positions of the cutting-off component and the grinding component are all located on a moving path of the manipulator.

2. The cutting-off and grinding integrated machine according to claim 1, wherein,
the cutting-off component comprises a rack, a cutting-off apparatus, and loading abutments, the loading abutments are disposed on two sides of a length direction of the rack, a cutting gap is disposed between the two loading abutments, and the two loading abutments are movable face to face or back to back to adjust a size of the cutting gap;
the two loading abutments are combined to form a storage platform for storing a crystal bar; and
the cutting-off apparatus is movably disposed in the length direction of the rack and passes through the cutting gap.

3. The cutting-off and grinding integrated machine according to claim 2, wherein,
the cutting-off apparatus comprises a mounting rack, a cutting wheel system, and a cutting wire saw;
the cutting wheel system is mounted on the mounting rack, the cutting wire saw is wound on the cutting wheel system, and a distance of two adjacent segments of the cutting wire saw in a cutting direction is greater than a length of the crystal bar; and
during cutting, only one segment of the cutting wire saw partially enters the cutting gap.

4. The cutting-off and grinding integrated machine according to claim 2, wherein,
each of the loading abutments is provided with a compression component abutting against the top of the crystal bar; and
the compression component comprises a driving cylinder, a connecting plate, and a compression head, the driving cylinder is disposed on the loading abutment, a driving end of the driving cylinder is movable in a height direction of the loading abutment and is connected with the connecting plate parallel to the top of the crystal bar, and the compression head is disposed on a portion, opposite to the top of the crystal bar, of the connecting plate.

5. The cutting-off and grinding integrated machine according to claim 4, wherein,
the compression component further comprises a first mounting seat, the driving cylinder is disposed in the first mounting seat, and the first mounting seat is disposed on the loading abutment; and
a positioning surface perpendicular to the loading abutment is disposed on a side, close to the cutting gap, of the first mounting seat, and the positioning surface abuts against a side of the crystal bar.

6. The cutting-off and grinding integrated machine according to claim 5, wherein the loading abutment and the positioning surface are provided with a protective part abutting against the crystal bar.

7. The cutting-off and grinding integrated machine according to claim 1, wherein the grinding component comprises a portal frame and at least two sets of grinding wheels symmetrically disposed on two sides of the portal frame, the grinding wheels comprise chamfer grinding components and plane grinding components, the chamfer grinding components and the plane grinding components are respectively disposed on front and rear sides of the portal frame, and each set of grinding wheels at least comprises two groups of chamfer grinding components.

8. The cutting-off and grinding integrated machine according to claim 7, wherein the grinding component further comprises a grinding platform, the grinding platform comprises grinding seats and a base, the grinding seats are respectively disposed on two sides of the base, the grinding seats are obliquely disposed, and a to-be-machined crystal bar is fixed to the grinding seats.

9. The cutting-off and grinding integrated machine according to claim 8, wherein an included angle between a surface, to which the crystal bar is fixed, of each of the grinding seats and an upper end surface of the base is 45 degrees.

10. The cutting-off and grinding integrated machine according to claim 8, further comprising first compression cylinders and an end gripping component, wherein,
the first compression cylinders are disposed on one side of the grinding seats, driving ends of the first compression cylinders abut against the crystal bar to fix the crystal bar to the grinding seats; and
the end gripping component comprises gripping arms and a moving mechanism, the moving mechanism is disposed on one side of the grinding seats, two gripping arms are disposed on two ends of the length direction of each of the grinding seats, and the two gripping arms are matched with the moving mechanism so as to be close to or away from each other.

11. The cutting-off and grinding integrated machine according to claim 8, wherein the manipulator comprises a body, a clamping structure, and a second compression cylinder, the clamping structure comprises two opposite clamping arms, the clamping arms are disposed on two ends of the body, and clamping blocks are rotatably disposed on the clamping arms; and the second compression cylinder is disposed on one side of the body, and a driving end of the second compression cylinder is movable in a height direction of the base.

12. The cutting-off and grinding integrated machine according to claim 8, further comprising a calibration component, wherein,
the calibration component comprises a tool setting apparatus and a benchmarking block, the tool setting apparatus comprises a tool setting fixing seat, a chamfer tool setting instrument, and a plane tool setting instrument, the tool setting fixing seat is disposed on the grinding platform, and the chamfer tool setting instrument and the plane tool setting instrument are both disposed on the tool setting fixing seat and are respectively opposite to the chamber grinding components and the plane grinding components;
each of the plane grinding components comprises a benchmarking sensor and a first driving apparatus, and the benchmarking sensor is opposite to the benchmarking block; and
the first driving apparatus drives the benchmarking sensor to move to the benchmarking block.

13. The cutting-off and grinding integrated machine according to claim 8, further comprising an oilstone component, wherein the oilstone component comprises chamfer grinding oilstones and plane grinding oilstones, and the chamfer grinding oilstones and the plane grinding oilstones are respectively disposed on portions, opposite to the chamfer grinding components and the plane grinding components, of the grinding platform.

14. The cutting-off and grinding integrated machine according to claim 1, further comprising air blowing components, wherein,
each of the air blowing component is disposed on a lower side of each of the cutting-off component and the grinding component, the air blowing component comprises an air blower component and a connecting pipe, and an end portion of the connecting pipe is connected with the air blower component; and
a plurality of air outlets are spaced along a length of the connecting pipe, and extension lines of orientations of the air outlets are staggered from an extension line of a length direction of the connecting pipe.

15. The cutting-off and grinding integrated machine according to claim 14, wherein the air blowing component further comprises a shielding part disposed on an upper side of the connecting pipe, and the orientations of the air outlets are opposite to the shielding part; the shielding part comprises an inclined plate and a guide plate, the inclined plate is opposite to the air outlets, the inclined plate is inclined downwards from the middle of the shielding part to a side of the shielding part, and the guide plate is connected to a side, away from the middle of the shielding part, of the inclined plate.

16. The cutting-off and grinding integrated machine according to claim 12, further comprising a protective component, wherein the protective component comprises a protective cover and a second driving apparatus, the protective cover is rotatably disposed on the grinding platform, and the protective cover covers the calibration component; and a driving end of the second driving apparatus is connected with the protective cover.

17. The cutting-off and grinding integrated machine according to claim 1, wherein,
the feeding component comprises a feeding conveyor belt and a first cleaning component, the first cleaning component is disposed on one end of the feeding conveyor belt, the first cleaning component comprises a first cleaning nozzle and a first cleaning brush, the first cleaning nozzle is opposite to the feeding conveyor belt, and the first cleaning brush abuts against the feeding conveyor belt;
the blanking component comprises a blanking conveyor belt and a second cleaning component, the second cleaning component is disposed on one end of the blanking conveyor belt, the second cleaning component comprises a second cleaning nozzle and a second cleaning brush, the second cleaning nozzle is opposite to the blanking conveyor belt, and the second cleaning brush abuts against the blanking conveyor belt; and
the transfer component further comprises a third cleaning component disposed on the manipulator, and the third cleaning component comprises a third cleaning nozzle opposite to the to-be-machined crystal bar.

18. The cutting-off and grinding integrated machine according to claim 1, wherein,
the machine body comprises a mounting base, and the cutting-off component and the grinding component are disposed on the mounting base;
the feeding component comprises a feeding conveyor belt, the blanking component comprises a blanking conveyor belt, one end of the feeding conveyor belt is used as a blanking position located between the cutting-off component and the grinding component, and the other end thereof is used as a feeding position away from the mounting base;
one end of the blanking conveyor belt is used as a feeding position located on one side of the grinding component, and the other end thereof is used as a blanking position away from the mounting base;
the feeding component further comprises a feeding rack, a positioning apparatus, and a size detection apparatus, the feeding rack is connected to a front side of the mounting base, and the feeding conveyor belt is disposed on the feeding rack;
the positioning apparatus comprises a positioning plate, a moving plate, and a driving cylinder, the positioning plate and the moving plate are respectively disposed on two sides of the feeding conveyor belt, the moving plate is movable to the positioning plate, and a driving end of the driving cylinder drives and is connected with the moving plate; and
the size detection apparatus is disposed on the feeding rack and is used for detecting a size of the crystal bar.

19. The cutting-off and grinding integrated machine according to claim 18, wherein,
the size detection apparatus comprises a width detection apparatus, a thickness detection apparatus, and a length detection apparatus, the width detection apparatus comprises a first contact sensor and a first driving motor, the first contact sensor is disposed on the feeding rack on the same side as the moving plate, and the first driving motor drives the first contact sensor to move to the positioning plate;
the thickness detection apparatus comprises a second contact sensor and a second driving motor, the second contact sensor is disposed above the feeding conveyor belt, and the second driving motor drives the second contact sensor to move to the feeding conveyor belt; and
the length detection apparatus comprises through-beam photoelectric sensors respectively disposed on two sides of the feeding conveyor belt.

20. A control method for a cutting-off and grinding integrated machine, which is applied to the cutting-off and grinding integrated machine according to claim 1, comprising the following steps:
after placing a crystal bar on the feeding component, moving the feeding component in the length direction of the machine body to convey the crystal bar to the blanking position of the feeding component;
then, transversely moving the manipulator to the blanking position of the feeding component in the width direction of the machine body to grab the crystal bar, then, transversely moving the manipulator to the machining position of the cutting-off component again, and performing a cutting-off process by the cutting-off component;
after completing the cutting-off process, grabbing the cut-off crystal bar by the manipulator and transversely moving the manipulator to the machining position of the grinding component, and sequentially performing a chamfer grinding process and a plane grinding process on the crystal bar by the chamfer grinding components and the plane grinding components; and
after completing the chamfer grinding process and the plane grinding process, grabbing the ground crystal bar by the manipulator and transversely moving the manipulator to the feeding position of the blanking component, and conveying the crystal bar out of the machine body by the blanking component.
